(19) United States
(12) Patent Application Publication
(10) Pub. No.: US 2021/0181037 A1
(43) Pub. Date: Jun. 17, 2021

(54) NON-INVASIVE TEMPERATURE MEASUREMENT OF PACKAGED FOOD PRODUCTS

(71) Applicant: THE COCA-COLA COMPANY, Atlanta, GA (US)

(72) Inventors: Michael G. IZENSON, Hanover, NH (US); Jed C. WILBUR, Cornish, NH (US); Scott D. PHILLIPS, Enfield, NH (US); Patrick J. MAGARI, Plainfield, NH (US)

(21) Appl. No.: 16/764,743

(22) PCT Filed: Nov. 16, 2018
(86) PCT No.: PCT/US2018/061489

§ 371 Date: May 15, 2020

Related U.S. Application Data
(60) Provisional application No. 62/587,567, filed on Nov. 17, 2017.

(51) Int. Cl. G01K 11/24

(52) U.S. Cl. CPC G01K 11/24; G01K 2207/04

(57) ABSTRACT

A non-invasive temperature measurement system comprises an ultrasound transducer configured to emit an ultrasound stimulus pulse toward a product package. An ultrasound receiver is configured to generate a reflected ultrasound waveform from electrical signals that represent physical characteristics of a plurality of reflected ultrasound pulses from a plurality of surfaces of the product package. A first reflected ultrasound pulse is from a first side of the product package closest to the transducer and a second reflected ultrasound pulse is from a second side of product package farthest from the transducer. A signal processor processes the reflected ultrasound waveform to determine a time lag between the first reflected ultrasound pulse and the second reflected ultrasound pulse. The time lag is then correlated to a temperature of a product in the product package. The ultrasound stimulus pulse does not induce nucleation of ice in a supercooled fluid.

### CROSS REFERENCE TO RELATED APPLICATIONS

This application claims the benefit of U.S. Provisional Patent Application Ser. No. 62/587,567 filed Nov. 17, 2017, the disclosure of which is expressly incorporated herein by reference.

### BACKGROUND

Packaged food products are typically maintained at a desired temperature at a point-of-sale. For example, packaged food products, such as beverages, may be maintained at a desired temperature inside a cooler at a convenience store or other outlet. Similarly, packaged food products, such as beverages, may be maintained at a desired temperature in a vending machine. However, such equipment maintains large numbers of products at the desired temperature relative to the number of products sold. Also, a single temperature set point is maintained for all of the products within a given compartment of the equipment. While equipment that cools a packaged food product may have a particular temperature set point, due to variations in product usage (e.g., dispensing a product from a vending machine or removing a product from a cooler), restocking ambient temperature products, air flow patterns within a storage volume, and other such variables, it is difficult to assure that the temperature of a given packaged food product is at a desired serving temperature at a given time. Furthermore, quickly and accurately determining the temperature of the packaged food product in a simple, non-invasive way is also difficult.

### SUMMARY

Aspects of the disclosure provide a non-invasive temperature measurement system. The non-invasive temperature measurement system comprises an ultrasound transducer configured to produce an ultrasound stimulus pulse directed toward a product packaging. The non-invasive temperature measurement system also comprises an ultrasound receiver configured to generate a reflected ultrasound waveform from electrical signals that represent physical characteristics of a plurality of reflected ultrasound pulses from a plurality of surfaces of the product packaging. The non-invasive temperature measurement system also comprises a signal processor configured to receive and process the reflected ultrasound waveform and determine a time lag between two of the plurality of reflected ultrasound pulses. The non-invasive temperature measurement system also comprises a database comprising a plurality of tables, wherein one of the tables correlates the time lag to a temperature of a product in the product packaging.

In some aspects of the disclosure, the plurality of reflected ultrasound pulses comprise a first reflected ultrasound pulse from a first side of the product packaging and a second reflected ultrasound pulse from a second side of the product packaging, wherein the time lag is between the first reflected ultrasound pulse and the second reflected ultrasound pulse.

In some aspects of the disclosure, the plurality of reflected ultrasound pulses comprise a third reflected ultrasound pulse between the first and second reflected ultrasound pulses.

In some aspects of the disclosure, the signal processor is further configured to detect ice in the product based on receiving the third reflected ultrasound pulse.

In any of the aspects of the disclosure described above, the ultrasound stimulus pulse has an operating frequency from 0.1 to 10 MHz, an operating amplitude of 100 to 100,000 Pa, and a pulse duration of 0.5 to 20 acoustic cycles.

In any of the aspects of the disclosure described above, the ultrasound stimulus pulse has an operating frequency between 0.4 to 225 MHz, an operating amplitude between 500 to 2000 Pa, and a pulse duration of 1 to 5 acoustic cycles.

In any of the aspects of the disclosure described above, the ultrasound stimulus pulse produces a mechanical index of less than 1.4

In any of the aspects of the disclosure described above, the non-invasive temperature measurement system further comprises a controller configured to communicate with the signal processor to receive the time lag, wherein the controller accesses the one of the tables to correlate the received time lag with the temperature of the product.

In any of the aspects of the disclosure described above, each of the tables correlates time lags to temperatures for a different product.

In any of the aspects of the disclosure described above, the one of the tables comprises a plurality of rows, where each row identifies a time lag value and a corresponding temperature value, and where each successive row is offset in the time lag value by greater than or equal to 0.01 μs.

A second aspect of the disclosure provides a rapid chilling system. The rapid chilling system comprises a cooling reservoir comprising a top with an aperture therein, a bottom, and a sidewall extending between the top and the bottom, wherein the cooling reservoir is adapted to cool a product package therein. The rapid chilling system also comprises an ultrasound transducer in the cooling reservoir and configured to emit an ultrasound stimulus pulse. The rapid chilling system also comprises a package handling system comprising a gripper mechanism adapted to grip the product package, the package handling system is configured to insert the product package into the cooling reservoir and manipulate the product package therein. The rapid chilling system also comprises an ultrasound receiver configured to generate a reflected ultrasound waveform from electrical signals that represent physical characteristics of a plurality of reflected ultrasound pulses from a plurality of surfaces of the product package. The rapid chilling system also comprises a processor configured to process the reflected ultrasound waveform and determine a time lag between two of the plurality of reflected ultrasound pulses and correlate the time lag to a temperature of a product in the product package.

In some of the second aspects of the disclosure, the cooling reservoir is configured to maintain a cooling fluid therein at a cooling temperature.

In any of the second aspects of the disclosure described above, the rapid chilling system further comprises a product identification system configured to identify the product package, wherein the processor is configured to correlate the time lag to a temperature of the product in the product package based on the identification of the product package.

In any of the second aspects of the disclosure described above, the rapid chilling system further comprises a database comprising a plurality of tables, wherein one of the tables correlates the time lag to the temperature of the product in the product package.

In any of the second aspects of the disclosure described above, the plurality of reflected ultrasound pulses comprise a first reflected ultrasound pulse from a first side of the product package and a second reflected ultrasound pulse from a second side of the product package, wherein the time lag is between the first reflected ultrasound pulse and the second reflected ultrasound pulse.

In some of the second aspects of the disclosure, the plurality of reflected ultrasound pulses comprise a third reflected ultrasound pulse between the first and second reflected ultrasound pulses.

In some of the second aspects of the disclosure, the processor is further configured to detect ice in the product based on the third reflected ultrasound pulse.

In any of the second aspects of the disclosure described above, the ultrasound stimulus pulse has an operating frequency from 0.1 to 10 MHz, an operating amplitude of 100 to 100,000 Pa, and a pulse duration of 0.5 to 20 acoustic cycles.

In any of the second aspects of the disclosure described above, the ultrasound stimulus pulse has an operating frequency between 0.4 to 2.25 MHz, an operating amplitude between 500 to 2000 Pa, and a pulse duration of 1 to 5 acoustic cycles.

In any of the second aspects of the disclosure described above, the ultrasound stimulus praise produces a mechanical index of less than 1.4

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a rapid chilling system suitable for implementing the several embodiments of the disclosure.

FIG. 2 illustrates sub-systems of the rapid chilling system suitable for implementing the several embodiments of the disclosure.

FIG. 3 illustrates a non-invasive temperature measurement sub-system of the rapid chilling system suitable for implementing the several embodiments of the disclosure.

FIG. 4 illustrates a processing sequence for correlating received ultrasound waveforms to a temperature of the product suitable for implementing the several embodiments of the disclosure.

FIG. 5 illustrates placer of an ultrasound transceiver relative to a bottle suitable for implementing the several embodiments of the disclosure.

FIG. 6 illustrates placement of an ultrasound transceiver relative to a can suitable for implementing the several embodiments of the disclosure.

FIG. 7 illustrates a non-invasive ice detection sub-system of the rapid chilling system suitable for implementing the several embodiments of the disclosure.

FIG. 8 illustrates a received ultrasound waveform showing the detection of a simulated ice crystal suitable for implementing the several embodiments of the disclosure.

FIG. 9 illustrates an exemplary computer system suitable for implementing several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents. Use of the phrase “and/or” indicates that any one or any combination of a list of options can be used. For example, “A, B, and/or C” means “A”, or “B”, or “C”, or “A and B”, or “A and C”, or “A and B and C”.

In the interest of clarity, throughout the specification the term “ultrasound pulse” refers to physical pressure pulsations in a medium (e.g., a product in a product packaging, the product packaging, and/or a cooling fluid surrounding the product packaging) of an emitted ultrasound wave. Likewise, throughout the specification, the term “waveform” refers to a graph or data representative of a graph that plots electrical signals that correspond in timing and amplitude to the pressure pulsations of ultrasound pulses.

The temperature of a packaged food product varies based on the operating conditions of equipment that is configured to cool the packaged food product. However, it is difficult to determine the temperature of a given packaged food product at a given time. A direct measurement of the temperature of the package food product may be accomplished through a thermocouple probe, but such measurement would pierce the product packaging. Non-invasive temperature measurements of the packaged food product may be accomplished with an infrared temperature sensor. However, this only measures a surface temperature of the packaged food product. For many food products that are contained in plastic packaging, which acts as an insulator, such surface temperatures do not accurately reflect the temperature of the packaged food product. Even with thermally conductive packaging, such as an aluminum can, the surface temperature may not account for any temperature gradients within the packaged food product. Note also that surfaces that are highly reflective will not accurately indicate the temperature of the contents.

Accordingly, n ultrasonic temperature measurement system is disclosed herein that facilitates a non-invasive accurate temperature measurement of an internal product temperature of a packaged food product. In some implementations, the ultrasonic temperature measurement system is used in a rapid chilling system as the packaged food product is manipulated in a cooling fluid bath to rapidly cool the packaged food product to a desired temperature. The ultrasonic temperature measurement system may also facilitate detecting the formation of ice within the packaged food product.

In some implementations, an ultrasonic transducer may be located within a cooling reservoir with a cooling fluid therein. A package handling system is configured to immerse a packaged food product within the cooling fluid of the cooling reservoir. As the packaged food product is cooled, the ultrasonic transducer may periodically emit an ultrasonic temperature sensing pulse. The ultrasonic temperature sensing pulse will reflect off of a near side of the packaging closest to the ultrasonic transducer to produce a first reflected pulse. The ultrasonic temperature sensing pulse will also pass through the packaging, travel through the food product contained therein, and reflect off of a far side of the packaging farthest from the ultrasonic transducer to produce a second reflected pulse. Both reflected pulses are detected by an ultrasonic transducer producing an electrical signal representative of the amplitude and timing of the reflected pulses. An ultrasound receiver may process the electrical signal produced by the ultrasound transducer to produce a reflected ultrasound waveform. The reflected ultrasound waveform is processed to determine a time lag between the two reflected pulses. The time lag will correlate to the temperature of the food product contained within the packaging. In the various embodiments of the disclosure, the packaged food product is a packaged beverage product.

The rapid chilling system may be part of a system for on-demand processing of chilled packaged food products. More specifically, a chilled packaged food product delivery platform is taught that promotes a consumer selecting or defining an individualized chilled food preference (e.g., hard frozen, lightly frozen, smooth textured, coarse textured, soft center with firm outside, firm center with soft outside, supercooled but not frozen, about the freezing point of the food product, a selected temperature of the food product, and the like) and then performs on-demand processing of the subject food product, in response to the consumer selection, to deliver the chilled packaged food product having the individualized food preference selected.

The phrase “on-demand processing of chilled packaged food products” means that the processing is performed and completed shortly before (e.g., about 10 seconds before, about 30 seconds before, about 2 minutes before, or less than about 5 minutes before) the packaged food product is delivered to a consumer, for example delivered to a human being for consumption. Such on-demand processing is distinct from processing of food products at a central food processing plant or factory where processed food products are then removed from the plant or factory for transportation to distribution points such as stores and restaurants. In the latter case, processing occurs hours if not days before the packaged food product is delivered to the consumer.

The packaged food product delivery platform may be considered to process food contained within a package in the context of a control system. In an embodiment, the platform comprises a package identification sub-system, a package handling and/or manipulation sub-system, a package chilling sub-system, a package delivery sub-system, a consumer interface sub-system, and a process control sub-system. It is understood, however, that the platform may be abstracted, sub-divided, or componentized differently. Additionally, the platform may comprise additional or fewer sub-systems and/or components than those identified above.

The platform controls physical parameters of the packaged food product over time to transform the food product from an initial state to a consumer selected end state. The platform may manipulate and/or control a temperature of the packaged food product, over time, by immersing the package in a chilled fluid bath, by controlling the temperature of the chilled fluid bath, and by moving and/or agitating the package within the chilled fluid bath. The rate or acceleration, maximum rotations per minute (RPM), time maintained at the maximum RPM, rate of deceleration, and time between spins of moving and/or agitating the package may be controlled and/or modulated by the platform. The platform may perform this manipulation in an open-loop framework that manipulates the packaged food product in a predetermined spin scheme and a predetermined spin profile for a predetermined amount of time based on the identified product. Product identification includes the type of food product (e.g., sugar sweetened carbonated beverage, diet carbonated beverage, juice beverage, smoothie, dairy beverage, yogurt product, etc.), type of packaging (e.g., PET carbonated beverage bottle, aluminum can, aluminum bottle, hot-fill PET beverage bottle, aseptic PET beverage bottle, etc.), and size of packaging (e.g., 20 fl. oz. package, 12 fl. oz. package, 8 fl. oz. package, etc.).

In some implementations, the platform may perform this manipulation in a closed-loop control framework that measures one or more of a temperature of the food product within the package, a torque applied to the package, a linear force applied to the package, an angular velocity of the package, a linear velocity of the package, and possibly other parameters of the package and/or of the platform sub-systems and/or components. The non-invasive temperature measurement provided by the pending disclosure allows for accurate control of the platform.

The quality or end state of a delivered chilled food product is the result of the initial state of the chilled food product and the time-integrated processing performed on the package containing the chilled food product. The processing of the food product using the packaged food product delivery platform taught herein facilitates the time-phased manipulations of independent physical packaged food process variables (packaged food product internal temperature, heat transfer coefficient, temperature gradients in the packaged food product, inlet chilled fluid temperature, outlet chilled fluid temperature, chilled fluid flow rate, torque applied to the package, linear force applied to the package, angular velocity of the package, linear velocity of the package, etc.). In the packaged food product delivery platform taught herein, a controller monitors the process variables and adapts the time-phased manipulations of the package containing the chilled food product. The quality and/or end state of the delivered chilled food product depends on the time-phased physical manipulations of the package containing the food product. Said in another way, the end state of the chilled food product is the effect not merely of its final temperature and temperature gradient but also of the pathway by which it reached its final temperature and temperature gradient from the initial state of the food product.

The chilled packaged food product delivery platform is provided with a plurality of chilled food processing recipes that the process control sub-system uses to process the chilled food products from initial state to delivered end state. The control sub-system, for example, may receive a consumer food preference selection and index or map from this preference selection to one of the chilled food processing recipes. The consumer food preference selection may be considered to further identify a particular chilled food product, for example a cola slushie, a smoothie slushie, a raspberry slushie, a strawberry slushie, a dairy freeze, or other product. Thus, the indexing to a chilled food processing recipe may be based both on the desired end state as well as on the selected or identified chilled food product, type of packaging, and size of packaging. Having found the appropriate processing recipe, the control sub-system executes the described food processing based on its monitoring of process variables. It is understood that the chilled food processing recipes may be increased or added to over time as new chilled food products are brought to market and/or as new food preferences are identified and defined.

It is contemplated that at least some processing of the chilled food product may be accomplished late in the process, for example at about the time the consumer is reaching for the package containing the chilled food product, or even after the package is in the hand of the consumer. This may increase the satisfaction of the consumer and/or the drama of presentation of the chilled food product. For example, the chilled food product delivery platform may be able to orchestrate nucleation of metastable (e.g., supercooled) food materials that enables transformation from a liquid or partially liquid state to a frozen or partially frozen state right before the consumer's eyes. The chilled food product delivery platform may chill the chilled food product to a metastable state and then apply a nucleation stimulus to the package, for example a mechanical shock or sharp brief linear acceleration or a sonic or ultra-sonic mechanical stimulus. Nucleation is the initial step that enables a phase change or state change of a material, for example from a fluid state to a solid state (e.g., from a liquid state to a frozen state). Nucleation may be considered to be a triggering event that allows the substance to overcome energy barriers that prevent it from achieving thermodynamic equilibrium.

Producing a range of different end states of a food product from the same initial state of the food product poses various technical challenges. For example, to provide different granularity or texture of the food product it may be desirable to chill the food product to a metastable state that is below the freezing point of the food product. Further, providing different degrees of metastability (e.g., how many degrees below the freezing point the food product is chilled) in a controlled manner may entail providing a chilled fluid that is significantly below the freezing point of the food product. Especially in such metastable states, it is important to detect the temperature of the food product within +/1−1° C. or even within less than +/1−1° C. in a non-invasive manner so as to prevent premature freezing of the food product or for freezing to be initiated at the wrong temperature.

Providing the desired granularity or texture of the product may depend upon controlled nucleation of metastable food product. Such controlled nucleation, in the machine and/or platform taught herein, may be provided by the delivery sub-system that may provide a range of nucleation stimuli such as one or more of a sharp physical blow, a sonic signal, a laser stimulation, or other. Moreover, the frequency and/or power of the nucleation stimuli may vary over time or with different food products as defined in the food processing recipes. Nucleation may occur while the chilled food product is in the chilled fluid and/or after the chilled food product is removed from the chilled fluid.

FIG. 1 illustrates a rapid chilling system 100 suitable for implementing the several embodiments of the disclosure. The rapid chilling system 100 includes a body 102 that encloses a plurality of sub-systems for rapidly chilling a food product to a desired temperature. A user interface of the rapid chilling system 100 includes a selection knob 104 and display screen 105. The display screen 105 displays a plurality of end-state temperatures for the packaged food product. For example, the display screen 105 may display a plurality of specific temperatures or temperature ranges (e.g., 40-45° F., 35-40° F. 32° F., 25-28° F., etc.). Other individual temperatures or temperature ranges between 10° F. and 50° F. may be used. At least one of the temperature options provided on the display screen is a temperature below the freezing point of the packaged food product. Alternatively or additionally, the display screen may display descriptions of end-state temperatures (e.g., cold, very cold, ice cold, supercooled, slush, frozen, etc.)

The control knob 104 is configured to be rotated by a consumer to select one of the displayed end-state temperatures. A selection indication on the display screen 105 highlights a different one of the displayed end-state temperatures for each rotational step that the control knob is rotated. In some implementations, the control knob 104 includes a button in a center thereof to actuate a selection. That is, upon a consumer rotating the control knob 104 to highlight a desired end-state temperature in the display screen 105, a consumer may actuate the button in the center of the control knob 104 to activate rapid chilling of a packaged food product to the selected end-state temperature.

A product door 106 is provided on the rapid chilling system 100 to facilitate the consumer inserting a packaged food product at a starting temperature into the rapid chilling system 100 and removing the packaged food product at the end-state temperature from the rapid chilling system 100. In some implementations, the starting temperature may be the ambient room temperature outside of the rapid chilling system 100. In some implementations, the starting temperature may be an intermediate temperature below the ambient room temperature and above the end-state temperature. For example, the packaged food product may be removed from a chilled storage container, such as a cooler or vending machine, which maintains the packaged food product at the intermediate temperature (e.g., 35-50° F.) and inserted into the rapid chilling system 100.

The product door 106 may be manually actuated, such as slid vertically or horizontally to open and close the product door 106, One or more sensors (not shown) may determine whether or not the product door 106 is open or closed. A workflow on the rapid chilling system 100 may be conditioned based on the product door sensor indicating that the door is open or closed. For example, in response to detecting that the product door 106 is open, the display screen 105 may transition to a screen that shows visual instructions for how to insert a packaged food product into the rapid chilling system 100 and close the product door 106. Upon detecting that the product door 106 is closed, the display screen 105 may again transition to a screen that facilitates selection of a desired end-state temperature. Other workflows are contemplated. In some implementations, the product door 106 is automatically actuated by a motor (not shown) based on one or more selections made on the user interface.

Other configurations of the body 102 of the rapid chilling system 100 are contemplated. For example, the display screen 105 may be a touchscreen display. In such embodiments, one or more of the control knob 104 and/or the button positioned therein may be eliminated.

Additionally, a nucleator (not shown) for initiating nucleation of ice in a supercooled fluid may be incorporated into the body 102 of the rapid chilling system 100 or provided alongside or adjacent to the rapid chilling system 100. In some implementations, the nucleator may include the ultrasonic nucleation device described in U.S. Pat. App. Pub. No. 2015/0264968 to Shuntich, entitled “Supercooled Beverage Crystallization Slush Device with illumination,” hereby incorporated by reference in its entirety.

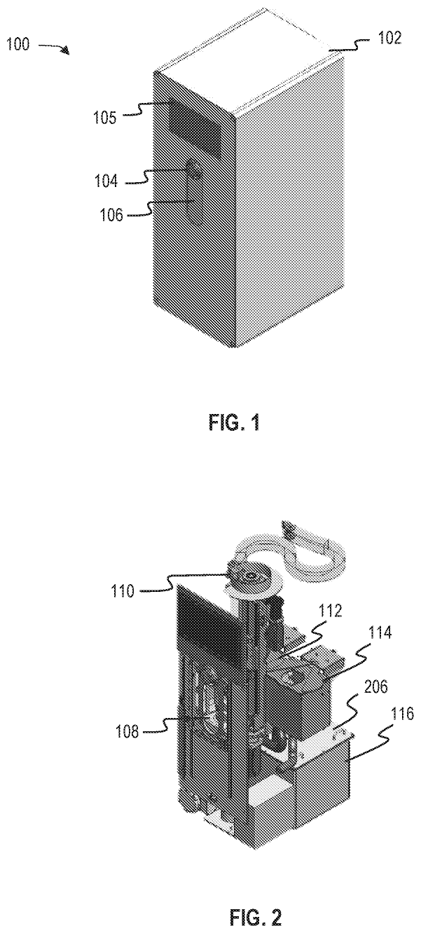

FIG. 2 illustrates sub-systems of the rapid chilling system 100 suitable for implementing the several embodiments of the disclosure. That is, FIG. 2 illustrates the rapid chilling system 100 with the exterior panels or cladding removed. As shown in FIG. 2, the rapid chilling system 100 includes a product identification sub-system 108, a product handling sub-system 110, a rapid chilling sub-system 112, a non-invasive temperature measurement sub-system 300 (not shown in FIG. 2), a washing sub-system 114, and a cooling sub-system 116.

Based on one or more of selection of a desired end-state temperature via the user interface of the rapid chilling system 100 and identification of the product by the product identification sub-system, a controller sub-system 126 (not shown in FIG. 2) may index, identify, or otherwise look up a chilled food processing recipe for the product. The chilled food processing recipe for the product may control operation of the other sub-systems described herein. For example, the chilled food processing recipe for the product may indicate an amount of time that the product is processed by the package handling sub-system 110 in the rapid chilling sub-system 112. The chilled food processing recipe for the product may indicate one or more product temperature set points for changing the operation of the package handling sub-system 110 (e.g., removing the product from the rapid chilling sub-system 112, changing the direction, speed, acceleration of rotation of the product in the rapid chilling sub-system 112, triggering one or more nucleation systems to initiate nucleation in a supercooled product in the rapid chilling sub-system, etc.). Upon the non-invasive temperature measurement sub-system 300 detecting a product temperature set point, the operation of the package handling sub-system 110 may be changed based on the indexed chilled food processing recipe for the product. Alternatively or additionally, the chilled food processing recipe for the product may indicate one or more product temperature set points for changing the operation of the rapid chilling sub-system 112. For example, one or more pumps or valves may be turned on or off upon detection of a product temperature set point.

The details of each of the sub-systems are not provided herein, but in various embodiments may be implemented as described in commonly owned application Ser. No. 62/586,454, attorney docket number 10851-007PV1, entitled, “System and Method for Rapid Cooling of Packaged Food Products,” hereby incorporated by reference in its entirety.

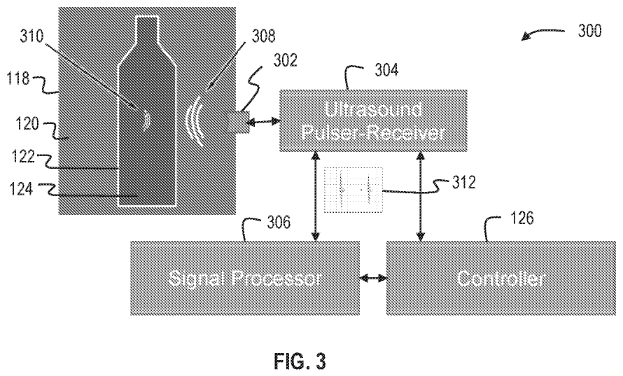

FIG. 3 illustrates a non-invasive temperature measurement sub-system 300 of the rapid chilling system 100 suitable for implementing the several embodiments of the disclosure. The non-invasive temperature measurement system 300 is part of the rapid chilling sub-system 112. The rapid chilling sub-system 112 includes a reservoir 118 with a chilling fluid 120 contained therein. The reservoir 118 is insulated to maintain the temperature of the chilling fluid 120.

The reservoir 118 has a top with an aperture therein, a bottom, and one or more sidewalk that extend between the top and the bottom. For example, the reservoir 118 may have a cylindrical shape with a single curved sidewall between the top and the bottom, a box shape with four sidewalls between the top and the bottom, or any other enclosed shape with one or more sidewalls between the top and the bottom. The bottom of the reservoir 118 may be in fluid communication with one or more pumps and or valves for circulating the chilling fluid 120 to be in thermal communication with the cooling sub-system 116 for maintaining the temperature of the chilling fluid 120. In various embodiments of the disclosure, the chilling fluid 120 may be maintained at a temperature below −10° C.

The aperture on the top of the reservoir 118 is sized and shaped to receive a packaged food product such as the product packaging 122 with a food product 124 therein, as shown in FIG. 3. Iii the example shown in FIG. 3, the packaging 122 is a beverage bottle and the food product 124 is a beverage. Other types of packaging and food products may be used. The package handling sub-system 110 (not shown in FIG. 3) facilitates insertion, removal, and manipulation of the packaging 122 within the chilling fluid 120 in the reservoir 118 so as to rapidly chill the product 124 to the desired end-state temperature.

The non-invasive temperature measurement sub-system 300 includes an ultrasound transducer 302, an ultrasound puller-receiver 304, and a signal processor 306. The ultrasound transducer 302 is mounted in a manner that enables it to produce an ultrasound pulse 308 directed at the package 122 through the chilling fluid 120. In some implementations, the ultrasound transducer 302 is mounted to a sidewall of the reservoir 118.

The ultrasound transducer 302 is configured to produce a stimulus ultrasound pulse 308 when it is excited by the ultrasound pulser-receiver 304. In other words, the ultrasound pulser-receiver 304 is configured to excite the ultrasound transducer 302 to produce the stimulus ultrasound pulse 308. The stimulus ultrasound pulse 308 is produced towards a center of the reservoir 118 or otherwise towards the packaging 122 when the packaging 122 is placed within the reservoir 118 by the package handling sub-system 110. In other words, the ultrasound transducer 302 is configured to produce the stimulus ultrasound pulse 308 towards a packaging insertion location within the reservoir 118 for receiving the packaging 122. The stimulus ultrasound pulse 308 may have an operating frequency from 0.1 to 10 MHz, an operating amplitude of 100 to 100,000 Pa, and a pulse duration of 0.5 to 20 acoustic cycles. In some implementations, the ultrasound pulse 308 has an operating frequency between 0.4 to 2.25 MHz, an operating amplitude between 500 to 2000 Pa, and a pulse duration of 1 to 5 acoustic cycles.

The ultrasound transducer 302 is also configured to transduce reflected ultrasound pulses 310 to a voltage for detection by the ultrasound pulser-receiver 304. In other words, the ultrasound pulser-receiver 304 is configured to generate a reflected ultrasound waveform 312 from the voltage transduced by the ultrasound transducer 302 from the reflected ultrasound pulses 310. The ultrasound pulser-receiver 304 generates electrical signals that correspond in timing and amplitude to the pressure oscillations that comprise the received ultrasound pulses 310. The representation of these electrical signals on a graph of voltage vs. time is the reflected ultrasound waveform 312. of the detected reflected ultrasound pulses 310.

In some implementations, rather than having a single transducer 302 transmit and receive ultrasound pulses, one or more ultrasound transducers may be configured to only transmit ultrasound pulses (e.g., the stimulus ultrasound pulse 308) and one or more ultrasound transducers may be configured to only receive ultrasound pulses (e.g., the reflected ultrasound pulses 310). Likewise, while the ultrasound pulser-receiver 304 is described above as a singular unit, a separate ultrasound pulser and ultrasound receiver may be provided. The separate ultrasound pulser may be configured to excite one or more ultrasound transducers. The separate ultrasound receiver may generate the reflected ultrasound waveform 312 from voltages transduced by one or more ultrasound transducers, which may be the same or different as the one or more ultrasound transducers excited by the separate ultrasound pulser.

When rapidly chilling a food product, such as a beverage, to supercooled temperatures, it is undesirable to unintentionally initiate a nucleation site for ice to form within the food product based upon the stimulus ultrasound pulse 308. Based on experimentation with the stimulus ultrasound pulse 308 with the above operating parameters, it was determined that the stimulus ultrasound pulse 308 only produced a mechanical index of less than or equal to 0.002 MPa/\sqrt{MHz}. Generally, cavitation in water is unlikely below a mechanical index of 1.4 MPa/\sqrt{MHz}. Therefore, the operating parameters of the stimulus ultrasound pulse 308 described above may be adjusted so long as the mechanical index produced by the ultrasound transducer 302. is less than 1.4 MPa/\sqrt{MHz}.

The stimulus ultrasound pulse 308 travels through the chilling fluid 120 and impinges upon a near side of the packaging 122. The terms “near” and “far” as used herein are from the perspective of the ultrasound transducer 302. For example, the near side of the packaging 122 is the closest side of the packaging 122 to the transducer 302, Similarly, the far side of the packaging 122 is the farthest side of the packaging 122 from the transducer. Upon impinging upon the near side of the packaging 122, a portion of the stimulus pulse 308 is reflected back to the transducer 302 to provide a first of the reflected ultrasound pulses 310. A portion of the stimulus pulse 308 also passes through the packaging 122, travels through the product 124, and impinges upon the far side of the packaging 122. Upon impinging upon the far side of the packaging, a second portion of the stimulus pulse 308 is reflected back to the transducer 302 to provide a second of the reflected ultrasound pulses 310. The second of the reflected pulses 310 also travels through the near side of the packaging 122 on the way back to the transducer 302.

The ultrasound pulser-receiver 304 receives transduced voltages of the first and second of the reflected ultrasound pulses 310 and passes signals representing the reflected ultrasound waveform 312 of the reflected ultrasound pulses 310 to the signal processor 306. The signal processor 306 processes the reflected ultrasound waveform 312 to determine a time lag between the first of the reflected pulses 310 from the near side of the packaging 122 and the second of the reflected pulses 310 from the far side of the packaging 122. Based on the determined time lag, the signal processor 306 correlates the time lag to a temperature of the product 124, for example using one or more charts or tables. The signal processor 306 reports the temperature of the product 124 to the controller sub-system 126 of the rapid chilling system 100, which in turn controls operation of the other sub-systems of the rapid chilling system 100 based upon the detected temperature of the product 124.

Surprisingly, it was discovered that this non-invasive method of measuring temperature of the product 124 is insensitive to the motion of fluid in the packaging 122 relative to the packaging 122. For example, in an experiment, a magnetic stirrer was placed within a beverage bottle with a beverage liquid contained therein. The beverage bottle was placed on top of a magnetic stir plate and a temperature of the beverage liquid was measured with a temperature probe. A time of flight through the beverage liquid of an ultrasound pulse was measured using an ultrasound transducer. As shown in Table 1 below, it was discovered that despite increasing the relative velocity of the beverage liquid in the bottle by stirring the magnetic stirrer up to 1200 rotations per minute. the time of flight of the ultrasound pulse was determined to remain constant within 0.01 μs.

TABLE 1

| Stir plate | Speed of bar | Temperature | Time of flight |
|---|---|---|---|
| setting | (RPM) | (° C.) | (μs) |
| Off | 0 | 22.2 | 46.09 |
| 2 | 60 | 22.2 | 46.09 |
| 4 | 125 | 22.1 | 46.09 |
| 6 | 350 | 22.2 | 46.09 |
| 8 | 700 | 22.2 | 46.09 |
| 10 | 1100 | 22.2 | 46.09 |
| 12 | 1200 | 22.2 | 46.08 |

While the non-invasive temperature measurement sub-system 300 shown in FIG. 3 and described above as detecting reflected ultrasound pulses from the ultrasound transducer 302 on one side of the reservoir 118, the non-invasive temperature measurement sub-system 300 may be configured in other ways to determine a time of flight measurement through the product 124. For example, rather than being mounted on a sidewall of the reservoir 118, the transducer 302 may be mounted below the packaging 124, for example as part of the package handling sub-system 110, to detect one or more reflected pulses to measure the time of flight of the pulses through the product 124. As a further alternative, the ultrasound pulser-receiver 304 may additionally be coupled to a second ultrasound transducer (not shown) on the opposite sidewall of the reservoir from the transducer 302 so as to measure the time of flight of an ultrasound pulse through the product 124 using a pitch-catch method. Other variations are readily apparent to those of ordinary skill in the art for measuring an ultrasound pulse time of through the product 124 using one or more ultrasound transducers and/or receivers.

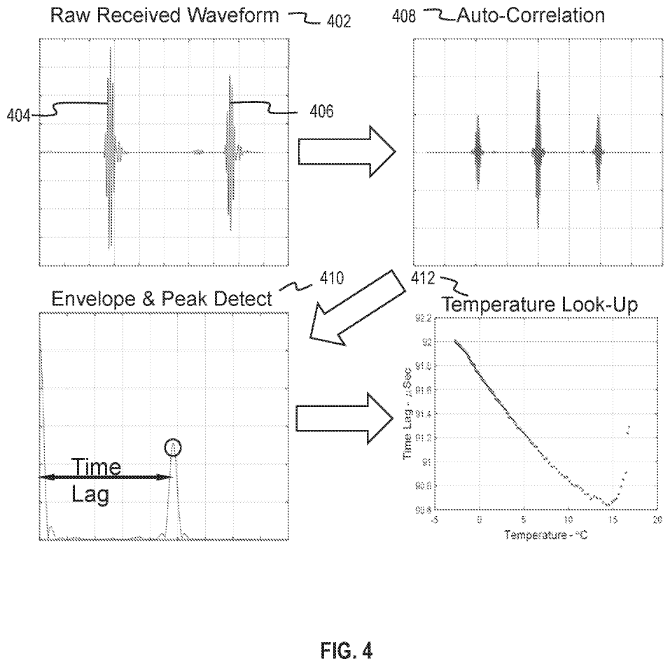

FIG. 4 illustrates a processing sequence for the signal processor 306 to correlate received ultrasound waveforms to a temperature of the product 124 suitable for implementing the several embodiments of the disclosure. At 402, the raw reflected ultrasound waveform 312 is received by the signal processor 306. The raw reflected ultrasound waveform 312 is shown in the graph in the top left corner of FIG. 4. As shown in FIG. 4, the reflected ultrasound waveform 312 includes a first reflected waveform 404 that is generated by the first of the reflected ultrasound pulses 310 from the near side of the packaging 122. The reflected ultrasound waveform 312 also includes a second reflected waveform 406 that is generated by the second of the reflected ultrasound pulses 310 from the far side of the packaging 122.

At 408, the signal processor 306 performs autocorrelation on the entire raw reflected waveform 312 (comprising reflected waveforms 404 and 406). The results of the autocorrelation performed by the signal processor 306 are shown in the graph in the top right corner of FIG. 4.

At 410, the signal processor 306 performs an envelope and peak detection operation on the autocorrelation result. The results of the envelope and peak detection operation performed by the signal processor 306 are shown in the graph in the bottom left corner of FIG. 4. The first non-zero peak resulting from the envelope and peak detection operation shows the time lag between the envelope peaks (e.g., the separation between a largest peak and a second largest peak).

At 412, the signal processor 306 performs a temperature look-up to a the detected time lag to a temperature of the product 124. The determined temperature is reported by the signal processor 306 to the controller sub-system 126 for controlling operation of the rapid chilling system 100.

For example, the signal processor may maintain a time-lag-to-temperature table for each product. Each table includes a plurality of rows of data, with each row identifying a time lag value and a temperature value. In some implementations, each successive row may include an offset in the time lag by greater than or equal to 0.01 μs and identify an experimentally determined temperature that corresponds with the time lag. In some implementations, each successive row may include a temperature offset greater than or equal to 0.1° C. and identify an experimentally determined time lag that corresponds with the temperature. In some implementations, the sensitivity provided by the time-lag-to-temperature table is about 0.1 μs/° C. In sonic implementations, the sensitivity provided by the time-lag-to-temperature table is about 0.39 to 0.64 □s/° C. In some implementations, the sensitivity provided is less than 1 μs/° C.

Alternatively, at 412, the signal processor 306 simply reports the determined time lag to the controller sub-system 126, which performs the temperature look-up. In this implementation, the controller sub-system 126 maintains the time-lag-to-temperature tables. Upon receiving the determined time lag from the signal processor 306, the controller 126 looks up the corresponding temperature from the time-lag-to-temperature table for the product 124.

In some implementations, the controller sub-system 126 and/or the signal processor 306 (e.g., via the controller sub-system 126) receives an identification of the product 124 from the product identification sub-system 108. Based on the product identification received from the product identification sub-system 108, the controller sub-system 126 and/or the signal processor 306 determines the appropriate time-lag-to-temperature table for the identified product 124.

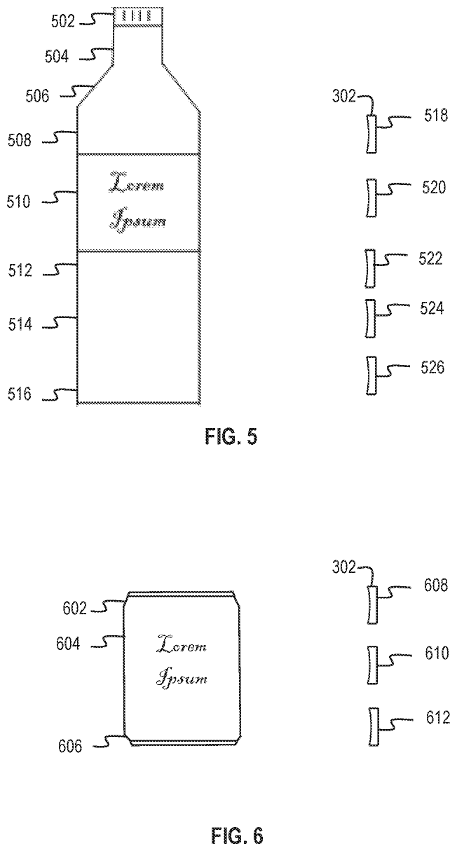

FIG. 5 illustrates placement of the ultrasound transducer 302 relative to a bottle suitable for implementing the several embodiments of the disclosure. Placement of the ultrasound transducer 302 relative to different locations on the bottle impacts performance of the time lag measurement. Generally, a bottle has a lid/cap 502, a neck 504, a shoulder 506, a top sidewall area 508, a label panel area 510, a waist 512, a pinch 514, and a base 516. As shown in FIG. 5, the transducer 302 may be placed at transducer locations 518-526 relative to the top sidewall area 510, label panel area 510, waist 512, pinch 514, and base 526, respectively. The location of the transducer 302 relative to a location on the bottle is adjusted by the package handling sub-system 110 placing the packaging 122 in the chilling reservoir 118 relative to the stationary placement of the transducer 302. in the reservoir 118. Different sizes and types of bottles may have different transducer locations. Based on the identification of the product 124 from the product identification sub-system 108, the package handling sub-system 110 may place the packaging 122 at an appropriate location in the chilling reservoir 118 to successfully non-invasively read the temperature of the product 124.

Looking again to FIG. 5, the transducer location 518 at the top sidewall area 508 has been found to be a reliably accurate location for sensing the lag time between reflected ultrasound pulses 310 in many different types of bottles. The transducer location 518 may also be ideal for detecting ice formation, discussed in more detail below, within the product 124 as the ice floats up within the product 124. The transducer location 520 about the label panel 510 of the bottle has been determined to not reliably sense the lag time between reflected ultrasound pulses 310 due to the additional interference and reflections caused by the label. The transducer location 522 at the waist 512 of the bottle has also been determined to not reliably sense the lag time between reflected ultrasound pulses 310 due to contouring and other aesthetic surface irregularities typical in many bottles. Similarly, transducer location 524 at the pinch 514 of the bottle has also been determined to not reliably sense the lag time between reflected ultrasound pulses 310 due to contouring and other aesthetic surface irregularities typical in many bottles, Transducer location 526 at the base 516 of the bottle has been found to be a reliably accurate location for sensing the lag time between reflected ultrasound pulses 310 in many different types of bottles.

FIG. 6 illustrates placement of the ultrasound transducer 302 relative to a can suitable for implementing the several embodiments of the disclosure. Placement of the ultrasound transducer 302 relative to different locations on the can impacts performance of the time lag measurement. Generally, a can has a top 602, a sidewall 604, and a base 606. As shown in FIG. 6, the transducer 302 may be placed at transducer locations 608-612 relative to the top 602, sidewall 604, and base 606, respectively. As above, the location of the transducer 302 relative to a location on the can is adjusted by the package handling sub-system 110 placing the packaging 122 in the chilling reservoir 118 relative to the stationary placement of the transducer 302 in the sidewall of the reservoir 118, Different sizes and types of cans may have different transducer locations. Based on the identification of the product 124 from the product identification sub-system 108, the package handling sub-system 110 may place the packaging 122 at an appropriate location in the chilling reservoir 118 to successfully non-invasively read the temperature of the product 124.

Looking again to FIG. 6, the transducer locations 608 and 612 have been determined to not reliably sense the lag time between reflected ultrasound pulses 310 due to contouring and other aesthetic surface irregularities typical in many cans at these locations. However, the transducer location 610 along the sidewall 604 of the can has been found to be a reliably accurate location for sensing the lag time between reflected ultrasound pulses 310 in many different types of cans. The transducer location 610 may also be ideal when located towards a top of the sidewall 604 for detecting ice formation, discussed in more detail below, within the product 124 as the ice floats up within the product 124.

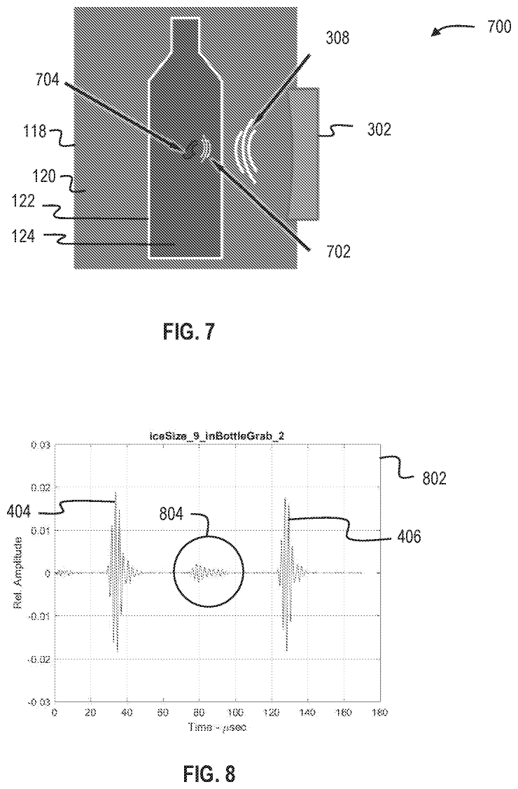

FIG. 7 illustrates a non-invasive ice detection sub-system 700 of the rapid chilling system suitable for implementing the several embodiments of the disclosure. The non-invasive ice detection sub-system 700 is substantially identical to the non-invasive temperature measurement system 300 described above, except the signal processor 306 is additionally configured to detect an intermediary reflected ultrasound pulse 702 from a particle of ice 704. That is, between the first and the second of the reflected ultrasound pulses 310, the stimulus ultrasound pulse 308 may further impinge upon the particle of ice 704, causing a third reflected ultrasound pulse 702 of the reflected ultrasound pulses 310. As described above, the reflected ultrasound pulses 310, including the third reflected ultrasound pulse 702, are transduced by the transducer 302 to electrical signals representative of the amplitude and timing of the reflected ultrasound pulses 310. The ultrasound pulser-receiver 304 receives the transduced electrical signals of the reflected ultrasound pulses 310 and generates a reflected ultrasound waveform 802 of the reflected ultrasound pulses 310. The ultrasound pulser-receiver 304 passes the reflected ultrasound waveform 802 to the signal processor 306.

FIG. 8 illustrates the raw reflected ultrasound waveform 802 received by the signal processor 306. The received ultrasound waveform 802 shows the detection of the ice 704 through the intermediary reflected waveform 804 between the first reflected waveform 404 and the second reflected waveform 406. As shown in FIG. 8, the intermediate reflected waveform 804 is produced from the third reflected ultrasound pulse 702 that reflected off of ice less than or equal to 1.9 mm wide.

In some implementations, the intermediary reflected waveform 804 has a minimum threshold amplitude so as to differentiate between a piece of ice and bubbles that may be in the product 122. In other words, the amplitude of the intermediary reflected waveform 804 is at least greater than the minimum threshold amplitude.

Upon the signal processor 306 detecting ice, the signal processor 306 sends an alert to the controller sub-system 126. Operation of the rapid chilling system 100 may be modified based upon the detection of ice in the product 122. For example, the product handling sub-system 110 may remove the packaging 122 from the rapid chilling reservoir 118 and provide the freezing product to a consumer during the process of freezing. In some implementations, the package handling sub-system 110 may manipulate the package in a different way upon detecting ice formation, for example, speeding up or slowing down or changing the direction of rotation of the packaging 12.

Other ice detection mechanisms may be used herein. For example, the formation of ice in a supercooled fluid is an exothermic process. Therefore, the formation of ice within the product could be detected based on detecting a sudden increase in the temperature of the fluid. For such ice detection mechanisms, the transducer location 526 may be preferred for bottles so as to avoid ice crystals from interfering with or generating spurious reflected ultrasound pulses when detecting the time lag between the reflected ultrasound pulses 310. Similarly, a bottom location along the sidewall 604 of a can may be a preferred location for the transducer 302 relative to the can.

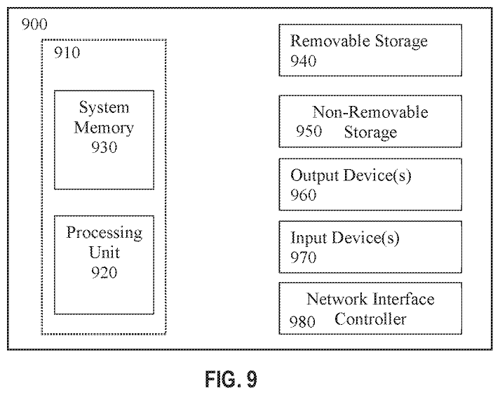

It should be appreciated that the logical operations described herein with respect the various figures may be implemented (1) as a sequence of computer implemented acts or program modules (i.e., software) running on a computing device (e.g., the computing device described in FIG. 9), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 9, an example computing device 900 upon which embodiments of the invention may be implemented is illustrated. For example, the signal processor 306 and/or the controller sub-system 126 of the rapid chilling system 100 may be implemented as a computing device, such as computing device 900. It should be understood that the example computing device 900 is only one example of a suitable computing environment upon which embodiments of the invention may be implemented. Optionally, the computing device 900 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In an embodiment, the computing device 900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device 900 to provide the functionality of a number of servers that is not directly bound to the number of computers in the computing device 900. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

n its most basic configuration, computing device 900 typically includes at least one processing unit 930 and system memory 920. Depending on the exact configuration and type of computing device, system memory 920 may be volatile (such as random access memory (RAM)), non-volatile (such as read-only memory (ROM), flash memory, etc.), or some combination of the two. This most basic configuration is illustrated in FIG. 9 by dashed line 910. The processing unit 930 may be a standard programmable processor that performs arithmetic and logic operations necessary for operation of the computing device 900. While only one processing unit 930 is shown, multiple processors may be present. Thus, while instructions may be discussed as executed by a processor, the instructions may be executed simultaneously, serially, or otherwise executed by one or multiple processors. The computing device 900 may also include a bus or other communication mechanism for communicating information among various components of the computing device 900.

Computing device 900 may have additional features/functionality. For example, computing device 900 may include additional storage such as removable storage 940 and non-removable storage 950 including, but not limited to, magnetic or optical disks or tapes. Computing device 900 may also contain network connection(s) 980 that allow the device to communicate with other devices such as over the communication pathways described herein. The network connections) 980 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing device 900 may also have input device(s) 970 such as a keyboards, keypads, switches, dials, mice, track balls, touch screens, voice recognizers, card readers, paper tape readers, or other well-known input devices. Output device(s) 960 such as a printers, video monitors, liquid crystal displays (LCDs), touch screen displays, displays, speakers, etc. may also be included. The additional devices may be connected to the bus in order to facilitate communication of data among the components of the computing device 900. All these devices are well known in the art and need not be discussed at length here.

The processing unit 930 may be configured to execute program code encoded in tangible, computer-readable media. Tangible, computer-readable media refers to any media that is capable of providing data that causes the computing device 900 (i.e., a machine) to operate in a particular fashion. Various computer-readable media may be utilized to provide instructions to the processing unit 930 for execution. Example tangible, computer-readable media may include, but is not limited to, volatile media, non-volatile media, removable media and non-removable media implemented in any method or technology for storage of information such as computer readable instructions, data structures, program modules or other data. System memory 920, removable storage 940, and non-removable storage 950 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

In an example implementation, the processing unit 930 may execute program code stored in the system memory 920. For example, the bus may carry data to the system memory 920, from which the processing unit 930 receives and executes instructions. The data received by the system memory 920 may optionally be stored on the removable storage 940 or the non-removable storage 950 before or after execution by the processing unit 930.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in correction with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Embodiments of the methods and systems may be described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through sonic interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A non-invasive temperature measurement system, comprising:
an ultrasound transducer configured to produce an ultrasound stimulus pulse directed toward a product packaging;
an ultrasound receiver configured to generate a reflected ultrasound waveform from electrical signals that represent physical characteristics of a plurality of reflected ultrasound pulses from a plurality of surfaces of the product packaging;
a signal processor configured to receive and process the reflected ultrasound waveform and determine a time lag between two of the plurality of reflected ultrasound pulses; and
a database comprising a plurality of tables, wherein one of the tables correlates the time lag to a temperature of a product in the product packaging.

2. The non-invasive temperature measurement system of claim 1, wherein the plurality of reflected ultrasound pulses comprise a first reflected ultrasound pulse from a first side of the product packaging and a second reflected ultrasound pulse from a second side of the product packaging, wherein the time lag is between the first reflected ultrasound pulse and the second reflected ultrasound pulse.

3. The non-invasive temperature measurement system of claim 2, wherein the plurality of reflected ultrasound pulses comprise a third reflected ultrasound pulse between the first and second reflected ultrasound pulses.

4. The non-invasive temperature measurement system of claim 3, wherein the signal processor is further configured to detect ice in the product based on receiving the third reflected ultrasound pulse.

5. The non-invasive temperature measurement system of claim 1, wherein the ultrasound stimulus pulse has an operating frequency from 0.1 to 10 MHz, an operating amplitude of 100 to 100,000 Pa, and a pulse duration of 0.5 to 20 acoustic cycles.

6. The non-invasive temperature measurement system of claim 1, wherein the ultrasound stimulus pulse has an operating frequency between 0.4 to 225 MHz, an operating amplitude between 500 to 2000 Pa, and a pulse duration of 1 to 5 acoustic cycles.

7. The non-invasive temperature measurement system of claim 1, wherein the ultrasound stimulus pulse produces a mechanical index of less than 1.4 MPa/\sqrt{MHz}.

8. The non-invasive temperature measurement system of claim 1, further comprising:
a controller configured to communicate with the signal processor to receive the time lag, wherein the controller accesses the one of the tables to correlate the received time lag with the temperature of the product.

9. The non-invasive temperature measurement system of claim 1, wherein each of the tables correlates time lags to temperatures for a different product.

10. The non-invasive temperature measurement system of claim 1, wherein the one of the tables comprises a plurality of rows, where each row identifies a time lag value and a corresponding temperature value, and where each successive row is offset in the time lag value by greater than or equal to 0.01 μs.

11. A rapid chilling system comprising:
a cooling reservoir comprising a top with an aperture therein, a bottom, and a sidewall extending between the top and the bottom, wherein the cooling reservoir is adapted to cool a product package therein;
an ultrasound transducer in the cooling reservoir and configured to emit an ultrasound stimulus pulse;
a package handling system comprising a gripper mechanism adapted to grip the product package, the package handling system is configured to insert the product package into the cooling reservoir and manipulate the product package therein;
an ultrasound receiver configured to generate a reflected ultrasound waveform from electrical signals that represent physical characteristics of a plurality of reflected ultrasound pulses from a plurality of surfaces of the product package; and
a processor configured to process the reflected ultrasound waveform and determine a time lag between two of the plurality of reflected ultrasound pulses and correlate the time lag to a temperature of a product in the product package.

12. The rapid chilling system of claim 11, wherein the cooling reservoir is configured to maintain a cooling fluid therein at a cooling temperature.

13. The rapid chilling system of claim 11, further comprising:
a product identification system configured to identify the product package, wherein the processor is configured to correlate the time lag to a temperature of the product in the product package based on the identification of the product package.

14. The rapid chilling system of claim 11, further comprising:
a database comprising a plurality of tables, wherein one of the tables correlates the time lag to the temperature of the product in the product package.

15. The rapid chilling system of claim 11, wherein the plurality of reflected ultrasound pulses comprise a first reflected ultrasound pulse from a first side of the product package and a second reflected ultrasound pulse from a second side of the product package, wherein the time lag is between the first reflected ultrasound pulse and the second reflected ultrasound pulse.

16. The rapid chilling system, of claim 15, wherein the plurality of reflected ultrasound pulses comprise a third reflected ultrasound pulse between the first and second reflected ultrasound pulses.

17. The rapid chilling system of claim 16, wherein the processor is further configured to detect ice in the product based on the third reflected ultrasound pulse.

18. The rapid chilling system of claim 11, wherein the ultrasound stimulus pulse has an operating frequency from 0.1 to 10 MHz, an operating amplitude of 100 to 100,000 Pa, and a pulse duration of 0.5 to 20 acoustic cycles.

19. The rapid chilling system of claim 11, wherein the ultrasound stimulus pulse has an operating frequency between 0.4 to 2.25 MHz, an operating amplitude between 500 to 2000 Pa, and a pulse duration of 1 to 5 acoustic cycles.

20. The rapid chilling system of claim 11, wherein the ultrasound stimulus pulse produces a mechanical index of less than 1.4 MPa/\sqrt{MHz}.
